(19) United States
(12) Patent Application Publication
(10) Pub. No.: US 2003/0169870 A1
(43) Pub. Date: Sep. 11, 2003

(54) Automatic call distribution

(76) Inventor: Michael Stanford, Dallas, TX (US)

Correspondence Address: Pillsbury Winthrop LLP, Intellectual Property Group, Attn: Roger R. Wise, 725 South Figueroa Street, Suite 2800, Los Angeles, CA, 90017-5406, US

(21) Appl. No.: 10/087,904

(22) Filed: Mar. 5, 2002

(51) Int. Cl. H04M 3/00; H04M 5/00

(52) U.S. Cl. 379/265.12

(57) ABSTRACT

Methods and apparatus for automatic call distribution (ACD) in a call queue are presented. Skill requirements are associated with a call in the call queue. Skill levels that correspond to the skill requirements are associated with each agent among a group of agents. A match rating is computed for each agent based on the skill requirements and skill levels. The call is then routed to an available agent based on the computed match rating for the agent. Accordingly, enhanced service levels may be achieved.

### BACKGROUND

1. Field

This invention relates to automatic call distribution (ACD) in a call queue.

2. Background and Related Art

Automatic call distribution (ACD) systems are employed in various organizational settings. A host of organizations, such as computer companies, insurance companies, utilities, airlines, and non-profits, offer customer service via telephone. In ACD systems, one or more groups of agents field calls placed by customers. Often, a customer dials a central number, and an ACD system routes the call to an available agent for handling.

The primary purpose of an ACD system is to achieve a target service level as efficiently as possible. An exemplary target service level criterion is to answer all calls within three rings. An exemplary efficiency criterion is that each agent is busy more than 90% of the agent's logged-in time. Such criteria are in opposition to one another.

An ACD system seeks to optimize service levels and efficiency by allocating calls to agents in real-time; displaying real-time service level information; and providing reports to assist supervisors in planning staffing levels. Secondary purposes of ACD systems include minimizing the number of hang-ups from held or abandoned calls, and routing calls to the agent or agents best qualified to assist the caller. The latter purpose is also known as skill-based routing.

The logical model of an ACD may include agents, supervisors, and calls. An agent is an individual who fields a call in a call queue. A supervisor is an individual who oversees the call queue. In overseeing the call queue, the supervisor may rely on ACD management software with a specialized user interface. In some settings, a supervisor also periodically acts as an agent. A call is a communication initiated by a caller who wishes to speak with an agent. ACD models generally group agents into agent groups. Similarly, ACD models group calls into call queues.

ACD systems consistent with such models route calls to agent groups primarily based upon the number dialed or on a selection made by the caller from a menu of options. For instance, in the airline industry, a caller who places a call to a new reservations number is routed to the agent group whose agents handle new reservations. When all the agents in a group are busy, the caller may be placed on hold or routed to another agent group. In some cases, there may be a one-to-one correspondence between call queues and agent groups. However, more complex schemes may be implemented.

Existing ACD schemes do not achieve optimal service levels and efficiency. Additionally, user interfaces for ACD supervisors do not optimally convey call queue information.

Therefore, what is needed is a method and apparatus for automatic call distribution.

### BRIEF DESCRIPTION OF THE DRAWINGS

FIG. 1 is a high-level diagram of an ACD system according to an embodiment of the present invention.

FIG. 2 is a high-level diagram of a server and call database according to an embodiment of the present invention.

FIG. 3 is a high-level flow diagram of a method according to an embodiment of the present invention.

FIG. 4 is a high-level flow diagram of a method according to an embodiment of the present invention.

FIG. 5 is a high-level diagram of a client according to an embodiment of the present invention.

FIG. 6 illustrates an exemplary display according to an embodiment of the present invention.

FIG. 7 is a high-level flow diagram of a method according to an embodiment of the present invention.

### DETAILED DESCRIPTION

The following detailed description refers to the accompanying drawings that illustrate exemplary embodiments of the present inventions. Other embodiments are possible and modifications may be made to the embodiments without departing from the spirit and scope of the invention. Therefore, the following detailed description is not meant to limit the invention. Rather, the scope of the invention is defined by the appended claims.

It will be apparent to one of ordinary skill in the art that the embodiments as described below may be implemented in many different embodiments of software, firmware, and hardware in the entities illustrated in the figures. The actual software code or specialized control hardware used to implement the present invention is not limiting of the present invention. Thus, the operation and behavior of the embodiments will be described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the presented embodiments may be stored in any storage device, such as, for example, a computer system (non-volatile) memory, an optical disk, magnetic tape, or magnetic disk. Furthermore, the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

Embodiments of the present invention relate to automatic call distribution (ACD) in a call queue. Various embodiments presented herein involve associating at least one skill requirement with a call. At least one corresponding skill level is associated with each agent among a group of agents. A match rating is computed for each agent based at least in part on the skill requirement associated with the call and on the skill level associated with the agent. A call is then routed to an available agent based at least in part on the computed match rating for the agent. Accordingly, an ACD system may achieve optimal service levels by routing calls to the agents best qualified to handle them.

Other embodiments involve a graphical user interface for automatic call distribution. A time axis associated with a call queue is displayed. The axis represents a predetermined interval of time associated with calls in the call queue. Call indicators corresponding to respective calls are displayed on the time axis. Status information for a call is selectively displayed for each call indicator. The time axis and call indicators are updated to reflect passage of time. Accordingly, a supervisor may more effectively oversee a call queue.

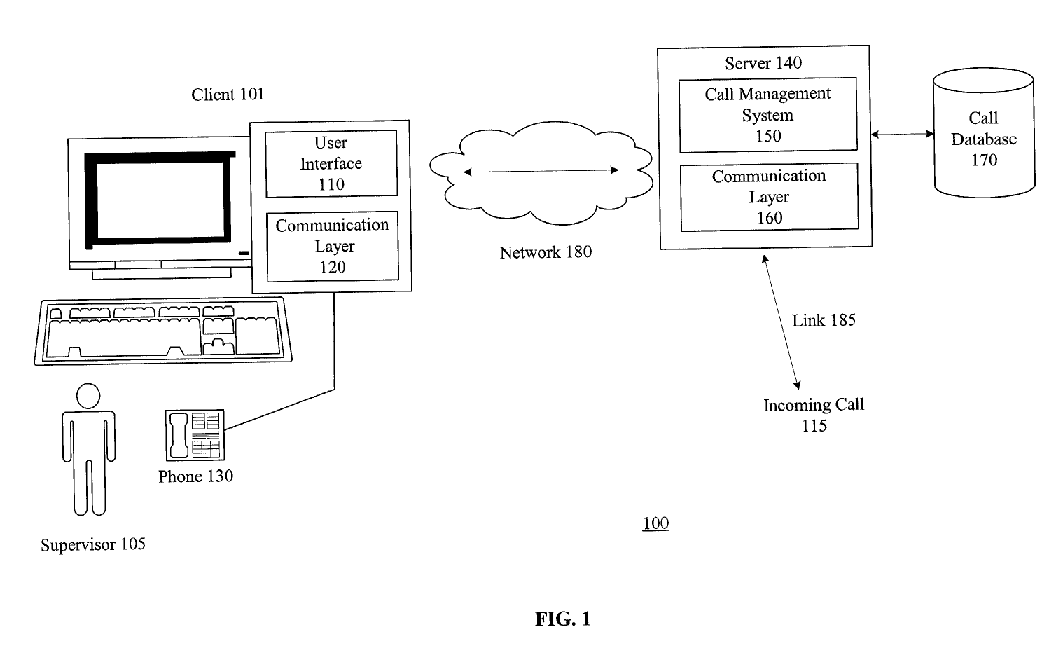

FIG. 1 is a high-level diagram of a system 100 for automatic call distribution (ACD) according to an embodiment of the present invention. System 100 includes a client 101, a server 140, a call database 170, and a phone 130. Client 101 and server 140 may be implemented, for example, as workstations, mainframes, or personal computers. Client 101 and server 140 may be integrated in one unit.

Client 101 and server 140 communicate over a network 180. Network 180 may comprise any of a number of exemplary networks, such as the Internet, an intranet, a voice over Internet Protocol (VoIP) network, a wireless network, an optical fiber network, or a cabled network.

Server 140 manages a queue of calls, such as an incoming call 115, received over a link 185. Link 185 may be provided by any of the networks listed above, as well as by a PSTN (public switched telephone network).

Server 140 includes a call management system 150 and a communication layer 160. Call management system 150 automatically manages calls in a queue. A user, such as a supervisor 105 or local area network (LAN) administrator of server 140, may control management of the calls by call management system 150. Communication layer 160 enables communication with client 101 over network 180, and with an outside caller (not shown) over link 185. Communication layer 160 also enables communication with other entities (not shown), such as clients and servers.

In an exemplary implementation, call management system 150 utilizes call database 170 as a repository for information relating to calls presently in a queue or queues associated with server 140, and/or relating to calls previously received and handled. Call database 170 may contain logging information that records, for example, duration of a call, holding/waiting time of a caller, identity of the agent fielding the call, caller ID information relating to the call, and other relevant information. It is to be appreciated that call database 170 need not be incorporated into various embodiments. Where incorporated, call database 170 may exist separately from server 140 or may be integrated into server 140.

Client 101 includes a user interface 110 and a communication layer 120. In exemplary implementations, user interface 110 enables an agent or supervisor 105 to (1) view or hear information relating to a call in a call queue; (2) record information relating to a call; (3) control routing of the call; and (4) retrieve and process summary information and status information relating to all or individual calls associated with a queue. Communication layer 120 facilitates communication over network 180 with server 140 or other entities that have network connectivity to network 180 or client 101.

Client 101 may optionally be coupled to a phone 130. As such, an agent or supervisor 105 may communicate with other agents or outside callers. In other embodiments, client 101 may include a virtual phone whose functionality is provided by hardware and software. In particular, client 101 may include hardware and software that is compliant with TAPI (Telephone Application Programmatic Interface) standards or analogous standards. Accordingly, client 101 may emulate telephone functions, such as voicemail, call recording, speed dial, and conferencing. Server 140 may be similarly configured.

Multiple clients 101 or multiple servers 140 may be incorporated into system 100. For instance, server 140 may route calls to other clients or servers (not shown) that manage call queues associated with various agent groups.

In an embodiment of the present invention, calls are assigned attributes, such as skills, age, and priority. A skill is an ability needed by the agent who assists a caller. A skill falls within a skill category. For instance, a skill category may be

Language, and skills in this category may include English, Spanish, etc. Another category may be Product or Geographical Region, for example.

In one embodiment, a supervisor 105 or other user defines, via a user interface such as user interface 110 in client 101, categories and defines skills within the categories. The data is then optionally saved to a nonvolatile memory.

In various embodiments, skills are binary with respect to calls. That is, for each skill defined within an ACD system, the call either requires the skill (a score of 100% or 1) or does not (a score of 0). Further, for each possible skill category, a call requires a maximum of one skill in that category. For example, a caller may call a support line for help on a particular product (Product X) in a particular language (English). Thus, the call requires the skill Product X (of the Product skill category) and the skill English (of the Language skill category). All other skills, whether falling within the Product or Language skill categories, respectively, or within other categories, are not required by the call.

In an ACD system according to various embodiments above, the number of call queues in a system is the combinatorial product of the number of skills in each skill category. For instance, if there are three skill categories with two skills in each category (see Table 1), there are (2)·(2)·(2)=8 call queues.

TABLE 1
Exemplary ACD Skill Categories and Skills

| Skill Category | Skill 1 | Skill 2 |
|---|---|---|
| Language | Spanish | English |
| Product | Product X | Product Y |
| Department | Customer Support | Sales |

The eight call queues are: (1) Spanish, Product X, Customer Support; (2) Spanish, Product X, Sales; (3) Spanish, Product Y, Customer Support; (4) Spanish, Product Y, Sales; (5) English, Product X, Customer Support; (6) English, Product X, Sales; (7) English, Product Y, Customer Support; and (8) English, Product Y, Sales.

An agent may be assigned a skill level that corresponds to a skill that is required by calls. The skill level, which may range from 0 (no skill) to 1 (most skilled) in some embodiments, takes into account varying skill levels of agents among a group. For example, an agent may be able to speak Spanish better than English, or to understand a first application program better than a second application program. At the same time, a first Spanish-speaking agent may be more or less fluent than a second Spanish-speaking agent. An agent may possess multiple skills in a skill category, and may have nonzero skill levels respectively corresponding to those skills.

In exemplary embodiments, calls are assigned to agents on the basis of skills. A system is typically in one of two states, namely, (1) there are more agents than calls, or (2) there are more calls than agents. If available agents lack the skills to service received calls, such calls may remain in call queues even when there are more agents than calls.

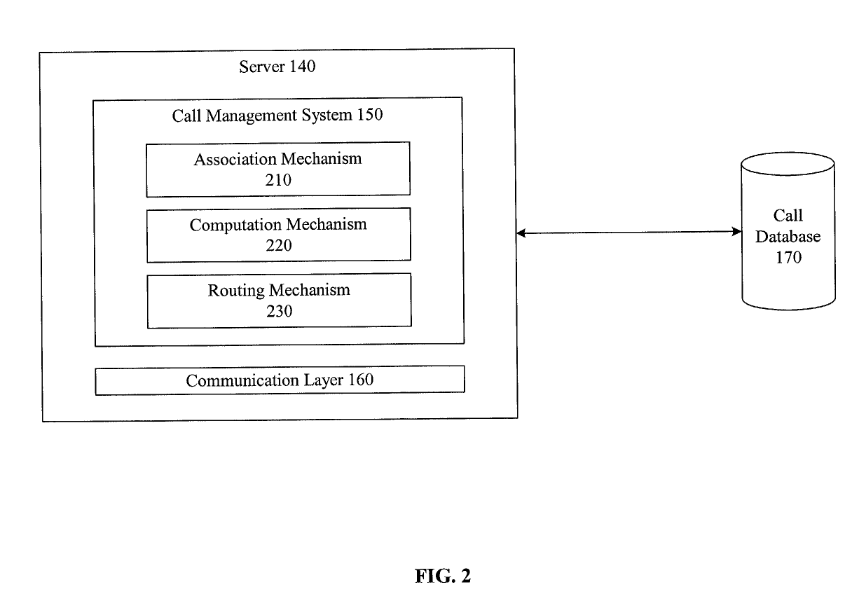

FIG. 2 illustrates server 140 and call database 170 in further detail. Call management system 150 of server 140 includes an association mechanism 210, a computation mechanism 220, and a routing mechanism 230.

Association mechanism 210 associates a call with one or more skills required for the call. Such skills may constitute skill requirements. Skill requirements may be provided to call management system 150 from an external location, such as a database; from a caller, based on a menu or on the number called; or from caller ID information, for example.

Association mechanism 210 may associate one or more skill levels with each agent that services a call queue. A supervisor or other user may also employ a user interface such as user interface 110 in client 101 to assign skill levels to agents. Defaults may also be employed for the assignments. The data is then optionally saved to a nonvolatile memory and used by call management system 150 of server 140 during runtime.

Association mechanism 210 may also associate a call age (hold time) and a call priority with a call. The call age may increment as the call remains in the call queue. The call priority may be set before or after the call reaches the ACD system, such as based on the number called (e.g., an emergency number) or on caller ID information. Exemplary call priority values range between 0 and 1 (100%).

Computation mechanism 220 computes a call match rating for each available agent based on the skill requirement(s) associated with the call and on the skill levels possessed by the agents. In one implementation, a match rating for each available agent is calculated as follows: A default rating of 1 (or another chosen value) is assigned to the call. For each skill required by the call, the call rating is cumulatively multiplied by the agent's skill level. The call then has a match rating for the agent.

If an agent lacks a required skill altogether-for example, the agent cannot speak Spanish (skill level =0)—then the match rating for that agent is zero.

For example, agent Number 6 may have the following skill levels:

TABLE 2
Exemplary Skill Levels for Agent Number 6

| Skill | Skill Level |
|---|---|
| Spanish | 0.7 |
| English | 1.0 |
| Product X | 0.3 |
| Product Y | 0.6 |
| Customer Support | 0.2 |
| Sales | 0 |

If a call requires that an agent have Spanish proficiency and an understanding of Product Y, then the match rating for Number 6 is (default rating for call)·(skill levels for required skills, Spanish and Product Y)=(1)·(0.7)·(0.6)=0.42. It is to be noted that the skill levels for skills not required by the call, but possessed by Number 6, do not enter into the match rating calculation for this embodiment.

Match ratings may also be computed for unavailable agents. For instance, if an unavailable agent is especially skilled in a particular skill relative to other agents, the caller may be placed on hold and routed to that particular agent once the agent becomes available.

Computation mechanism 220 may compute an urgency factor for a call. Urgency may be computed by multiplying the call priority (between 0.1 and 1, 1 being the highest priority), by the call's wait time (between 0 and 1, 1 being the normalized maximum specified wait time).

Routing mechanism 230 routes a call to an available agent based on the computed match rating for the available agent. In one embodiment, the agent with the highest nonzero match rating receives a call. When, for instance, the only Spanish-speaking agent is already on a call, all available agents score zero for a call that requires a Spanish-speaking agent. In such a case, the call may go on hold until the Spanish-speaking agent becomes available or the urgency of the call exceeds a threshold value and generates some kind of exception, such as to route the call to another call center with Spanish-speaking agents.

Routing mechanism 230 may route a call on the basis of other factors, such as urgency and/or fairness factors. Override criteria may also affect routing. Override criteria may include account number associated with the caller, caller ID information, and exceptions. For instance, a call may be routed to a particular agent based on a specific measure, such as caller ID, when the caller has an established relationship with the particular agent.

When there are more calls than agents, the following events may occur in certain implementations. When an agent becomes free, the agent's match rating for each call in the call queue is computed as described above. The urgency of the call is then computed. For each call, the agent's match rating is multiplied by the call's urgency, and the highest scoring call goes to the agent. If all the calls score 0, they all remain in the call queue until a more appropriate agent becomes available.

When there are more agents than calls, one implementation may include the use of a fairness factor for agents as a routing tool. In particular, as an agent sits idle without receiving a call, the agent's computed match rating may be modified or overridden to ensure that the most skilled agents do not get all of the calls and the less skilled agents remain permanently idle. Exemplary fairness factors include longest idle, least recently called, and lowest duty cycle during the latest x logged-in hours.

Exceptions may be generated in call management system 150. For instance, a maximum and/or a target average hold time may be set to generate an exception. When there are not enough agents, that is, when the call volume-to-agent capacity exceeds a threshold value, for example, an exception also may be generated. When no agent is logged in for a required skill, an exception may be generated as well.

Exemplary ways of handling exceptions may include call queue overflow wherein (a) busy signals are generated; (b) calls are routed to another call center; (c) alarms are generated; (d) skill requirements are reduced, which make more agents available; (e) a supervisor is paged; and (f) the caller is offered other options, such as those presented via a DTMF or speech recognition menu. Instructions may be sent along with a diverted call to instruct an agent how to handle the diverted call.

In other embodiments, skill-based routing rules may be overridden by call management system 150. For instance, calls for a sales call queue group that bear a particular account number or caller ID may be tagged to go to the collections department if the caller's account is delinquent or if a particular agent is assigned to the caller. A related routing scheme may include tracking the agents with whom each caller has talked in the past and attempting to match the caller and agents up again.

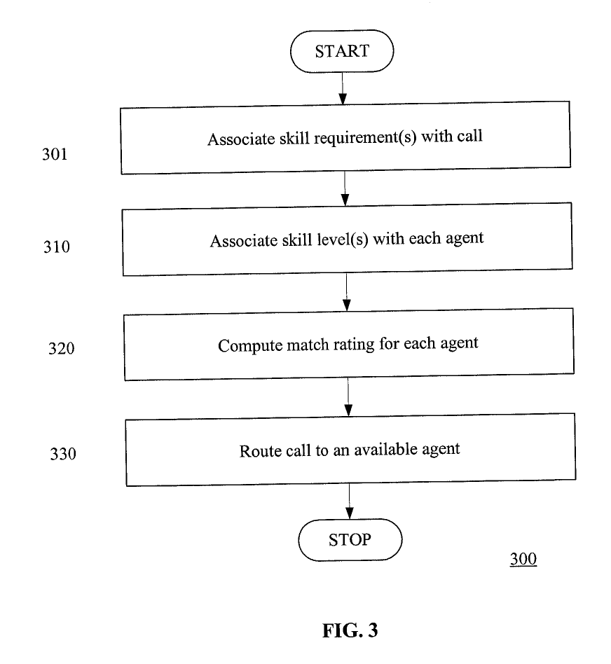

FIG. 3 is a high-level flow diagram of a method 300 according to an embodiment of the present invention. In task 301, one or more skill requirements are associated with a call. In task 310, one or more skill levels are associated with each agent. In task 320, a match rating is computed for each available agent. In task 330, the call is routed to an available agent.

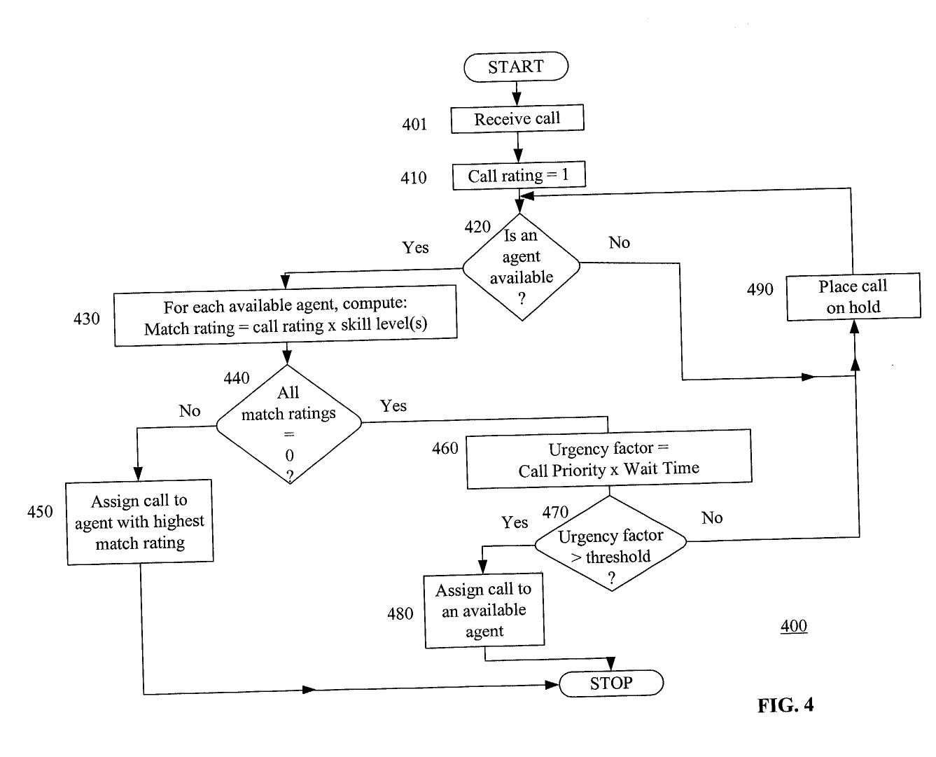

FIG. 4 is a high-level flow diagram of a method 400 according to an embodiment of the present invention. In task 401, a call is received. The call is assigned a default call rating of 1 in task 410. In task 420, the method determines whether an agent is available to field the call. If an agent is not available, then the caller is placed on hold in task 490, and the method returns to task 420 to check for available agents. If an agent is available in task 420, then in task 430, for each available agent, a match rating is computed. The match rating is computed by multiplying the call rating for the call by each skill level for which a skill is required by the call.

In task 440, the method tests whether all match ratings for the available agents are 0. If not, then in task 450, the call is assigned to an agent with the highest match rating. The method then ceases.

If all match ratings for available agents are 0, then an urgency factor for the call is computed in task 460. The urgency factor is computed by multiplying the call priority by the wait time. In task 470, the method tests whether the urgency factor exceeds a threshold. If not, then the caller is placed on hold in task 490 as above. If the urgency factor does exceed the threshold in task 470, then the call is assigned to an available agent in task 480. The method then ceases.

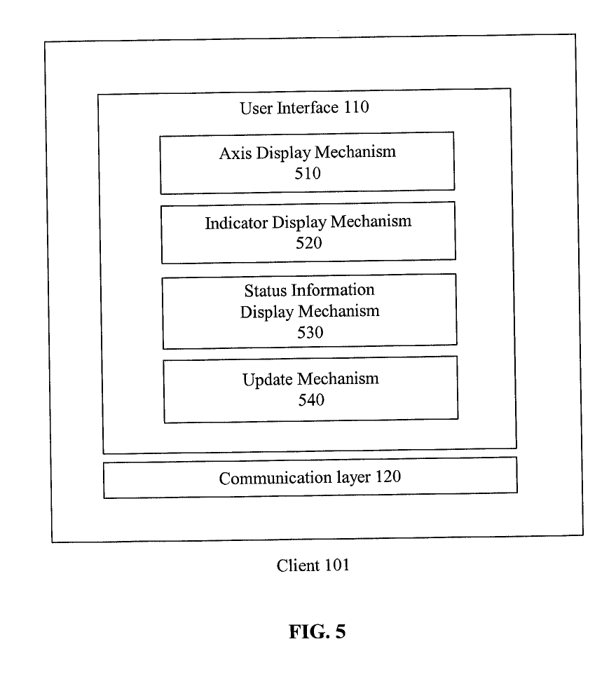

FIG. 5 is a high-level diagram that illustrates client 101 in more detail according to an embodiment of the present invention. Various components of client 101 also may be implemented on server 140 or another computer. User interface 110 of client 101 includes an axis display mechanism 510, an indicator display mechanism 520, a status information display mechanism 530, and an update mechanism 540. User interface 110 may be programmed in any suitable programming language, such as Java, Visual Basic, or C++.

Axis display mechanism 510 displays, on an output device, such as a monitor or LCD screen, a time axis associated with a call queue. The axis represents a predetermined interval of time associated with calls in the call queue.

Indicator display mechanism 520 displays call indicators on the time axis. Each of the call indicators corresponds to a respective call. The position of each call indicator may correspond to a time at which the call entered the call queue.

Status information display mechanism 530 selectively displays, for each call indicator, status information for the corresponding call. The displaying of such status information may be triggered by the selection of the respective call indicator.

Update mechanism 540 updates the time axis and call indicators to reflect the passage of time. The updating may occur at predetermined intervals or on an ad hoc basis linked to system-or user-defined events.

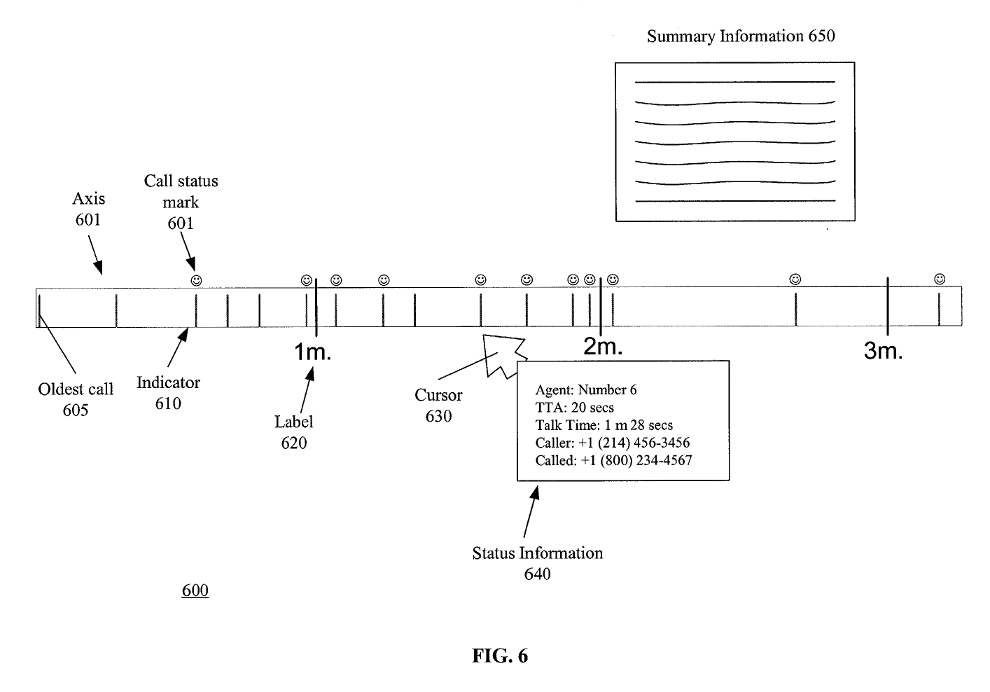

FIG. 6 illustrates a display 600 for an agent or supervisor graphical user interface according to an embodiment of the present invention. Display 600 may also be implemented for server 140 and/or may be viewable via the World Wide Web. As shown, a time axis 601 spans a time period that includes calls presently in the call queue. In other embodiments, time axis 601 may also include calls formerly in the call queue. In still other embodiments, a user may dynamically select among several views, wherein past or present time slices of call activity may be rendered, and information associated therewith may be displayed or retrieved for display. As such, time axis 601 stretches or shrinks in order to display the calls.

Information displayed in display 600 may be stored in volatile or nonvolatile memory. In one embodiment, displayed information is stored in a central location, such as in call database 170 of server 140. However, client 101 itself may include a repository for the information.

As shown in FIG. 6, time axis 601 may include labels 620 which identify specific instances of time related to the call queue. In the embodiment of FIG. 6, each label 620 identifies whole numbers of minutes that have elapsed since receipt of the oldest call presently in the queue. In particular, the label 620 “1 m.” denotes an instant that is about one minute since the oldest call 605 presently in the queue was received.

Call indicators 610 on time axis 601 identify calls in the call queue. Indicators 610 may be positioned at points that correspond to when the respective calls were received. Indicators 610 may have varying representations. For instance, a call indicator 610 may, as in FIG. 6, take on the form of a vertical line that is perpendicular to and intersects time axis 601. In other implementations, various indicia, such as icons or shapes, may be used to represent calls.

In still other embodiments, indicator 610 may have varying representations depending on whether a call has been answered by an agent or whether the call remains on hold in the call queue. For example, calls that have been answered may be represented by an indicator 610 that is shaded green. In contrast, calls that have not been answered by an agent may be represented in the color red.

In particular, in FIG. 6, indicators 610 for answered calls are accompanied by call status marks 615 in the shape of a smiling face. Thus, in FIG. 6, sixteen calls are represented. Five calls are holding, and eleven have been answered.

Display 600 may include status information 640 that corresponds to each of the calls presently in the call queue. Status information 640 may be selectively displayed on display 600.

In various implementations, status information 640 may be selectively displayed based on user input or based on preprogrammed or preset parameters. Specifically, when a user moves a cursor 630 over or near a particular call indicator, as shown, status information 640 may appear in a pop-up box or other form. Status information 640 may include any of a host of information, such as agent handling the call; time to answer (TTA) (the length of time the call was in the queue before being answered by an agent); talk time (duration of the call); caller number; number called by the caller; and name of the caller, as provided by account ID or caller ID information (not shown). Status information 640 may also be automatically displayed by user interface 110, which may scan through the calls in the call queue at predetermined or preselected intervals and display associated status information 640 for finite periods.

In another embodiment, a call history graph (not shown) may be selectively displayed when a user moves cursor 630 over or near a particular call indicator. The call history graph may graphically represent the history of the particular call. For instance, the graph may include a multi-colored ribbon with segments indicative of various call states. For an exemplary call, the leftmost end of the ribbon may include a blue segment (to denote call ringing), and the ribbon may successively transition to segments that are light blue (to denote navigation of menus by the caller); red (to denote caller on hold); green (to denote call answered); and another shade of green (to denote that the caller has been transferred to a second agent).

In still another embodiment, the call history graph may be a two-dimensional graph charting call match rating (CMR) (positive ordinate axis Y) and call status (negative ordinate axis Y) versus time (positive abscissa axis t). For an exemplary call, the leftmost end of the time axis (beginning with time t=0) may include a horizontal segment at Y=0 (to denote call ringing). At t=10 seconds, the graph stepwise drops to Y=−0.5 (to denote navigation of menus by the caller). The graph stepwise drops to Y=−0.1 at t=20 seconds (to denote caller on hold); rises to Y=+0.4 at t=2.4 minutes (to denote that the caller is speaking to an agent whose associated CMR is 0.4); and rises to Y=+0.9 at t=3.8 minutes (to denote that the caller has been transferred to a second, more qualified agent whose CMR is 0.9).

In addition to status information 640, display 600 may display summary information 650 for the queue. Summary information 650 may include various information, such as (1) number of calls; (2) average time ringing of calls; (3) longest time ringing of calls; (4) number of calls in the queue; (5) average time in queue; (6) longest time in queue; (7) number of calls talking to agents; (8) average time talking to agents; (9) longest time talking to agents; (10) number of logged-in agents that possess particular skills; and (11) number of calls holding that require particular skills. With the inclusion of such summary information 650 or variations thereof, a supervisor utilizing display 600 may more effectively oversee operations of the queue and take preemptive or remedial steps to enhance customer service.

In the exemplary queue of FIG. 6, the oldest call 605 is slightly older than three minutes even though eleven newer calls have already been answered. Oldest call 605 may require a skill that is currently not possessed by available agents. Until agents become available that provide the required skill, the call remains on hold. However, urgency factors or fairness criteria may be applied, as described above, to prevent the caller from holding an excessively long time.

In one embodiment, a call indicator 610 may begin flashing when the caller has been on hold longer than a predetermined time. In other embodiments, all call indicators 610 may begin flashing when the call queue is in an overflow state. Display 600 may display the number of calls that have been rerouted to other call queues.

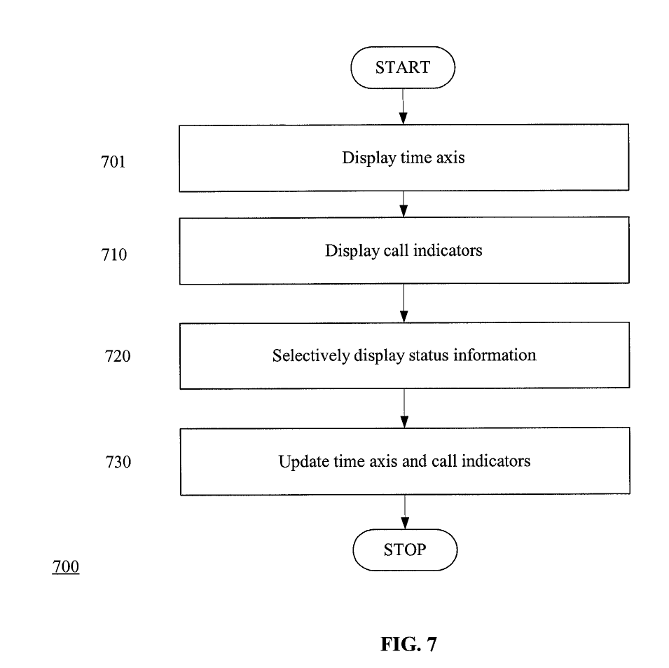

FIG. 7 is a high-level flow diagram of a method 700 according to an embodiment of the present invention. In task 701, a time axis is displayed. In task 710, call indicators are displayed. Status information for a call is selectively displayed in task 720. In task 730, the time axis and call indicators are updated.

The foregoing description of the various embodiments is provided to enable any person skilled in the art to make and use the present invention and its embodiments. Various modifications to these embodiments are possible, and the generic principles presented herein may be applied to other embodiments as well.

Further, the invention may be implemented in part or in whole as a hard-wired circuit, as a circuit configuration fabricated into an application-specific integrated circuit, or as a firmware program loaded into non-volatile storage, or a software program loaded from or into a data storage medium as machine-readable code. Such code being instructions executable by an array of logic element such as a microprocessor or other digital signal processing unit.

As such, the present invention is not intended to be limited to the embodiments shown above but rather is to be accorded the widest scope consistent with the principles and novel features disclosed in any fashion herein.

What is claimed is:

1. A method of automatic call distribution in a call queue, comprising:
associating at least one skill requirement with a call;
associating at least one skill level with each agent among a group of agents, the skill level corresponding to the at least one skill requirement of the call;
computing a match rating for each agent based at least in part on the at least one skill requirement associated with the call and on the at least one skill level associated with the agent; and
routing the call to an available agent based at least in part on the computed match rating for the available agent.

2. The method of claim 1, wherein the call is routed based at least in part on a highest match rating criterion.

3. The method of claim 1, wherein the computing the match rating includes cumulatively multiplying a predetermined value by each skill level for which the call has a corresponding skill requirement.

4. The method of claim 3, wherein the predetermined value includes a default rating.

5. The method of claim 1, wherein a skill level is a number between 0 and 1.

6. The method of claim 5, wherein a skill level of 0 for an agent indicates that the agent lacks a skill associated with the skill level.

7. The method of claim 6, further comprising placing the call on hold if a skill level for each agent among the agents is 0.

8. The method of claim 1, further comprising placing the call on hold if an agent is not available.

9. The method of claim 1, wherein a call in the call queue has an associated call priority and wait time, further comprising computing an urgency factor for the call in the call queue, and routing the call to an available agent based at least in part on the urgency factor.

10. The method of claim 9, wherein the computing the urgency factor includes multiplying the call priority by the wait time.

11. The method of claim 9, wherein a call priority depends at least in part on caller ID information associated with the call.

12. The method of claim 1, wherein the call is routed to an available agent based at least in part on a fairness criterion.

13. The method of claim 12, wherein the fairness criterion includes one of idle time of the agent, a number of calls previously fielded by the agent, and duty cycle of the agent.

14. The method of claim 1, wherein the call is routed to an available agent based at least in part on an override criterion.

15. The method of claim 14, wherein the override criterion includes one of an account number associated with the caller, caller ID information, and an exception.

16. A server for automatic call distribution in a call queue, comprising:
an association mechanism configured to associate at least one skill requirement with a call, and to associate at least one skill level with each agent among a group of agents, the skill level corresponding to the at least one skill requirement of the call;
a computation mechanism configured to compute a match rating for each agent based at least in part on the at least one skill requirement associated with the call and on the at least one skill level associated with the agent; and
a routing mechanism configured to route the call to an available agent based at least in part on the computed match rating for the available agent.

17. The server of claim 16, wherein the call is routed based at least in part on a highest match rating criterion.

18. The server of claim 16, wherein the match rating is computed, at least in part, by cumulatively multiplying a predetermined value by each skill level for which the call has a corresponding skill requirement.

19. The server of claim 18, wherein the predetermined value includes a default rating.

20. The server of claim 17, wherein a skill level is a number between 0 and 1.

21. The server of claim 20, wherein a skill level of 0 for an agent indicates that the agent lacks a skill associated with the skill level.

22. An article of manufacture comprising:
a machine-accessible medium comprising data that cause a machine to,
associate at least one skill requirement with a call in a call queue;
associate at least one skill level with each agent among a group of agents,
the skill level corresponding to the at least one skill requirement of the call;
compute a match rating for each agent based at least in part on the at least one skill requirement associated with the call and on the at least one skill level associated with the agent; and
route the call to an available agent based at least in part on the computed match rating for the available agent.

23. The article of manufacture of claim 22, wherein the call is routed based at least in part on a highest match rating criterion.

24. The article of manufacture of claim 22, wherein the match rating is computed, at least in part, by cumulatively multiplying a predetermined value by each skill level for which the call has a corresponding skill requirement.

25. The article of manufacture of claim 24, wherein the predetermined value includes a default rating.

26. The article of manufacture of claim 22, wherein a skill level is a number between 0 and 1.

27. The article of manufacture of claim 26, wherein a skill level of 0 for an agent indicates that the agent lacks a skill associated with the skill level.

28. In a graphical user interface for automatic call distribution, a method comprising:
displaying a time axis associated with a call queue, the axis representing a predetermined interval of time associated with calls in the call queue;
displaying call indicators on the time axis, each of the call indicators corresponding to a respective call and being displayed at a position on the time axis that corresponds to a time at which the call was added to the call queue;
selectively displaying, for each call indicator, status information for the corresponding call, the displaying being triggered by the selection of the respective call indicator; and
updating the time axis and call indicators to reflect passage of time.

29. The method of claim 28, wherein a respective call indicator is selected at least in part by user input.

30. The method of claim 29, wherein the user input includes the positioning of a cursor on or near the respective call indicator.

31. The method of claim 28, wherein a respective call indicator is selected at least in part by an automated procedure.

32. The method of claim 28, wherein a call indicator is substantially perpendicular to the time axis.

33. The method of claim 28, wherein a call indicator associated with an answered call is displayed in a first color, and a call indicator associated with an unanswered call is displayed in a second color.

34. The method of claim 28, wherein the predetermined interval of time includes a time at which an oldest call in the queue was received.

35. The method of claim 28, wherein the status information is displayed in a pop-up window.

36. The method of claim 28, further comprising displaying summary information for calls in the queue.

37. The method of claim 36, wherein the summary information includes at least one of: number of calls in the queue, average waiting time of a call, average holding time of a call, longest time in the queue, and longest time talking.

38. The method of claim 28, wherein a call indicator flashes when a respective call is on hold longer than a predetermined time.

39. The method of claim 28, wherein a call indicator for a call has a predetermined representation depending on whether the call is an answered or unanswered call.

40. The method of claim 28, wherein a call indicator has an associated call status indicator.

41. An apparatus for automatic call distribution, comprising:
an axis display mechanism configured to display a time axis associated with a call queue, the axis representing a predetermined interval of time associated with calls in the call queue;
an indicator display mechanism configured to display call indicators on the time axis, each of the call indicators corresponding to a respective call and being displayed at a position on the time axis that corresponds to a time at which the call was added to the call queue;
a status information display mechanism configured to selectively display, for each call indicator, status information for the corresponding call, the displaying being triggered by the selection of the respective call indicator; and
an update mechanism configured to update the time axis and call indicators to reflect passage of time.

42. The apparatus of claim 41, wherein a respective call indicator is selected at least in part by user input.

43. The apparatus of claim 42, wherein the user input includes the positioning of a cursor on or near the respective call indicator.

44. The apparatus of claim 41, wherein a respective call indicator is selected at least in part by an automated procedure.

45. An article of manufacture comprising:
a machine-accessible medium comprising data that cause a machine to,
display a time axis associated with a call queue, the axis representing a predetermined interval of time associated with calls in the call queue;
display call indicators on the time axis, each of the call indicators corresponding to a respective call and being displayed at a position on the time axis that corresponds to a time at which the call was added to the call queue;
selectively display, for each call indicator, status information for the corresponding call, the displaying being triggered by the selection of the respective call indicator; and
update the time axis and call indicators to reflect passage of time.

46. The article of manufacture of claim 45, wherein a respective call indicator is selected at least in part by user input.

47. The article of manufacture of claim 46, wherein the user input includes the positioning of a cursor on or near the respective call indicator.

48. The article of manufacture of claim 45, wherein a respective call indicator is selected at least in part by an automated procedure.
